(19) United States
(12) Patent Application Publication
(10) Pub. No.: US 2019/0319534 A1
(43) Pub. Date: Oct. 17, 2019

(54) CHARGE PUMP

(71) Applicant: Wuhan Xinxin Semiconductor Manufacturing Co., Ltd., Wuhan (CN)

(72) Inventors: Yuan TANG, San Jose, CA (US); Zhifeng MAO, Wuhan (CN); Yi LUO, Wuhan (CN); Byoung Kwon CHA, San Jose, CA (US); Jen-Tai HSU, San Jose, CA (US)

(21) Appl. No.: 16/223,674

(22) Filed: Dec. 18, 2018

(30) Foreign Application Priority Data
Apr. 12, 2018 (CN) 201810327003.4

(51) Int. Cl. H02M 3/07

(52) U.S. Cl. CPC H02M 3/073; H02M 2003/077; H02M 2003/075

(57) ABSTRACT

A charge pump is disclosed, including: multiple charge-pump stages connected sequentially; multiple switches, coupled between output of a corresponding one of charge-pump stages and output of charge pump; multiple second switches, coupled, at one end, to output of a corresponding one of charge-pump stages and to input of immediately succeeding one of charge-pump stages at other end; and multiple third switch, coupled between output of corresponding one of charge-pump stages and input of charge pump. First, second and third switches are opened or closed to determine a number of charge-pump stages connected in series and a number of charge-pump stages connected in parallel. The greater the number of charge-pump stages connected in series in charge-pump cascade is, the higher output voltage of charge pump will be, and the greater the number of charge-pump stages connected in parallel in charge-pump cascade, the higher drive current produced by charge pump will be.

### CROSS-REFERENCE TO RELATED APPLICATION

This application claims the priority of Chinese patent application number 201810327003.4, filed on Apr. 12, 2018, the entire contents of which are incorporated herein by reference.

### TECHNICAL FIELD

The present invention relates to the field of semiconductor technology and, in particular, to a charge pump.

### BACKGROUND

A charge pump usually has a number of stages which are cascaded to achieve a desired voltage and a corresponding drive ability. An existing charge pump typically includes a charge-pump cascade consisting of multiple charge-pump stages connected in series and a voltage regulator. For example, in a five-stage charge-pump cascade structure, an input of the first charge-pump stage is connected to a supply voltage, while a high voltage is supplied at an output of the fifth charge-pump stage.

The voltage regulator is configured for voltage clamping and typically includes a comparator and two resistors connected in series between the output of the fifth charge-pump stage and the ground. A feedback voltage output from the connection node between the two resistors is coupled to an inverting input of the comparator, with a non-inverting input of the comparator being coupled to a reference voltage.

Such an existing charge pump can easily satisfy a design need for an output voltage up to 7-8 V and a drive current of 10-30 μA. However, some practical applications may impose higher requirements on charge pumps. For example, for an EEPROM, a high voltage of 7 V may satisfy the need of its programming operations, but its data reading operations may require a voltage of for example 2-3 V, which is lower than the programming voltage and higher than the supply voltage. At the same time, a relatively great drive current of 200-300 μA is required. The conventional practice to address the need for such a great drive current is to increase the capacitance and the number of cascaded stages. However, this will greatly expand the size of the charge pump. Thus, the conventional charge pump is faced with the dilemma of having to increase its capacitance and stage count at the expense of compromised efficiency and size expansion in order to provide a lower voltage and a greater drive current.

### SUMMARY OF THE INVENTION

It is an object of the present invention to provide a charge pump so as to overcome the problem of a lack of flexibility associated with the conventional charge-pump cascades.

To this end, the present invention provides a charge pump, comprising:

a plurality of sequentially connected charge-pump stages;

a plurality of first switches, each coupled between an output of a corresponding one of the charge-pump stages and an output of the charge pump;

a plurality of second switches, each coupled between an output of a corresponding one of the charge-pump stages and an input of an immediately succeeding one of the charge-pump stages; and

a plurality of third switches, each coupled between an output of a corresponding one of the charge-pump stages and an input of the charge pump,

wherein a charge-pump cascade structure is formed by individually configuring an open or close status of each of the first, second and third switches, and wherein a number of series-connected charge-pump stages and a number of parallel-connected charge-pump stages in the charge-pump cascade structure are determined by the open or close status of the respective first, second and third switches, and,

wherein a greater number of the series-connected charge-pump stages in the charge-pump cascade structure, enable a higher output voltage of the charge pump, and the greater a number of the parallel-connected charge-pump stages in the charge-pump cascade structure, enable a higher drive current produced by the charge pump.

Optionally, in the charge pump, in among the plurality of sequentially connected charge-pump stages, an input of a leading one of the charge-pump stages serves as an input of the charge-pump cascade structure, and an output of a trailing one of the charge-pump stages serves as an output of the charge-pump cascade structure.

Optionally, in the charge pump, an input of the charge-pump cascade structure may be coupled to a supply voltage and an output of the charge-pump cascade structure is coupled to a load.

Optionally, in the charge pump, a number of the first switches may be one less than a number of the charge-pump stages.

Optionally, in the charge pump, a number of the second switches may be one less than a number of the charge-pump stages.

Optionally, in the charge pump, a number of the third switches may be one less than a number of the charge-pump stages.

Optionally, in the charge pump, the plurality of charge-pump stages are connectable in parallel by closing each of the first and third switches and opening each of the second switches.

Optionally, in the charge pump, the plurality of charge-pump stages are connectable in series by opening each of the first and third switches and closing each of the second switches.

Optionally, in the charge pump, each of the charge-pump stage may comprise two sub-stages which are connected in series, one of the two sub-stages having an input serving as an input of the charge-pump stage, the other one of the two sub-stages having an output serving as an output of the charge-pump stage.

Optionally, the charge pump may further comprise a plurality of fourth switches, wherein in each of the charge-pump stages, a node between the two sub-stages is connected to a supply voltage via a corresponding one of the fourth switches and the sub-stages is e coupled to a clock signal.

In the charge pump proposed in the present invention, through a configuration of the first, second and third switches, and opening or closing of the first, second and third switches to change the connection relationship among the charge-pump stages (series or parallel), thereby forming different charge-pump cascade structures enabling provide different output voltages and drive current abilities that can address various drive ability needs for circuits. In this manner, a great drive current can be achieved without increasing the capacitance or the number of stages, offering significant size and cost savings.

### BRIEF DESCRIPTION OF THE DRAWINGS

FIG. 1 shows a structural schematic of a charge pump according to an embodiment of the present invention.

FIG. 2 shows a diagram schematically illustrating a parallel-connected charge-pump cascade structure according to another embodiment.

FIG. 3 shows a diagram schematically illustrating a series-connected charge-pump cascade structure according to a further embodiment.

FIG. 4 shows a structural schematic of a charge-pump stage according to a further embodiment of the present invention.

### DETAILED DESCRIPTION

The charge pump constructed in accordance with this invention will be described below in further detail with reference to the accompanying drawings and specific embodiments. Features and advantages of the invention will be more apparent from the following detailed description, and from the appended claims. It is noted that the figures are provided in a very simplified form not necessarily presented to scale, with the only intention to facilitate convenience and clarity in explaining the embodiments of the invention.

The core concept of the present invention is to provide a charge pump so as to overcome the problem of lacking flexibility associated with the conventional charge-pump cascades.

To this end, the charge pump of the present invention includes: a plurality of charge-pump stages connected sequentially; a plurality of first switches, each coupled between an output of a corresponding one of the charge-pump stages and an output of the charge pump; a plurality of second switches, each coupled to an output of a corresponding one of the charge-pump stages at one end and to an input of an immediately succeeding one of the charge-pump stages at the other end; and a plurality of third switches, each coupled between an output of a corresponding one of the charge-pump stages and an input of the charge pump. The first, second and third switches are individually opened or closed to form different charge-pump cascade structures with various output voltages and drive currents. The greater the number of charge-pump stages connected in series in a charge-pump cascade structure is, the higher the output voltage of the charge pump will be. In another aspect, the greater the number of charge-pump stages connected in parallel in a charge-pump cascade structure is, the higher the drive current produced by the charge pump will be.

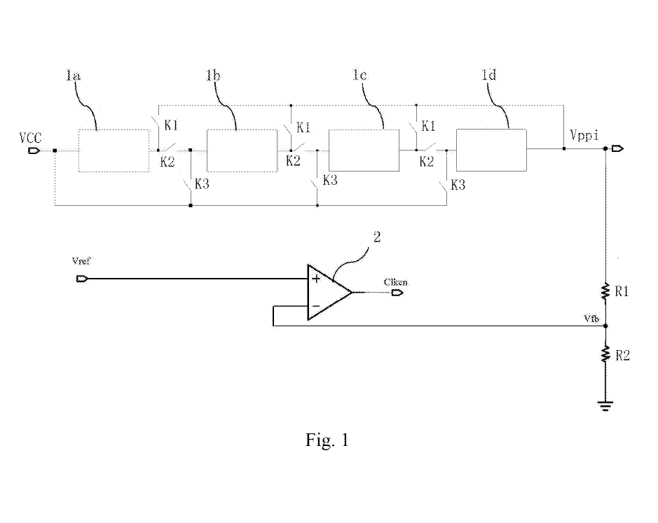

As shown in FIG. 1, a charge pump according to an embodiment of the present invention includes a plurality of charge-pump stages connected sequentially. The embodiment will be described below with four charge-pump stages included as an example, which are a first charge-pump stage 1a, a second charge-pump stage 1b, a third charge-pump stage 1c and a fourth charge-pump stage 1d. The charge pump further includes: a plurality of first switches K1, each coupled between an output of a corresponding one of the charge-pump stages and an output of the charge pump; a plurality of second switches K2, each coupled to an output of a corresponding one of the charge-pump stages at one end and to an input of an immediately succeeding one of the charge-pump stages at the other end (e.g., to an output of the 1a at one end and to an input of 1b at the other end); and a plurality of third switches K3, each coupled between an output of a corresponding one of the charge-pump stages and an input of the charge pump. The first, second and third switches K1, K2, K3 are individually opened or closed to form different charge-pump cascade structures with various output voltages and drive currents. The greater the number of charge-pump stages connected in series in a charge-pump cascade structure is, the higher an output voltage of the charge pump will be. The greater the number of the charge-pump stages connected in parallel in a charge-pump cascade structure is, the higher the drive current produced by the charge pump will be.

The charge pump may further include a voltage regulator configured for voltage clamping. The voltage regulator may include a comparator 2, a first resistor R1 and a second resistor R2. The first resistor R1 is connected to an output of the charge-pump cascade structure at one end and to the second resistor R2 at the other end. The other end of the second resistor R2 may be grounded. The comparator 2 may have: a non-inverting input coupled to a reference voltage Vref; an inverting input coupled to a feedback voltage Vfb provided at the connection node of the first resistor and the second resistor; and an output that outputs a clock signal clken.

Specifically, in the charge pump, an input of a leading one (i.e., 1a) of the plurality of sequentially connected charge-pump stages may serve as the input of the charge-pump cascade structure, and an output of a trailing one (i.e., 1d) of the plurality of charge-pump stages may serve as the output of the charge-pump cascade structure. The input of the charge-pump cascade structure may be coupled to a supply voltage VCC, with its output coupled to a load Vppi.

Preferably, the number of the first switches K1 is one less than the number of the charge-pump stages. The number of the second switches K2 is one less than the number of the charge-pump stages. And the number of the third switches K3 is one less than the number of the charge-pump stages.

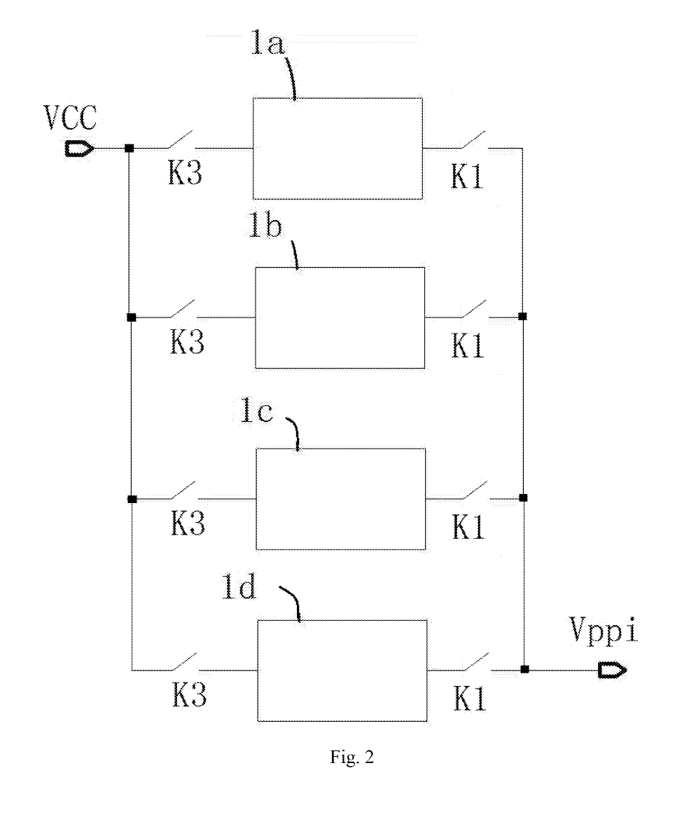

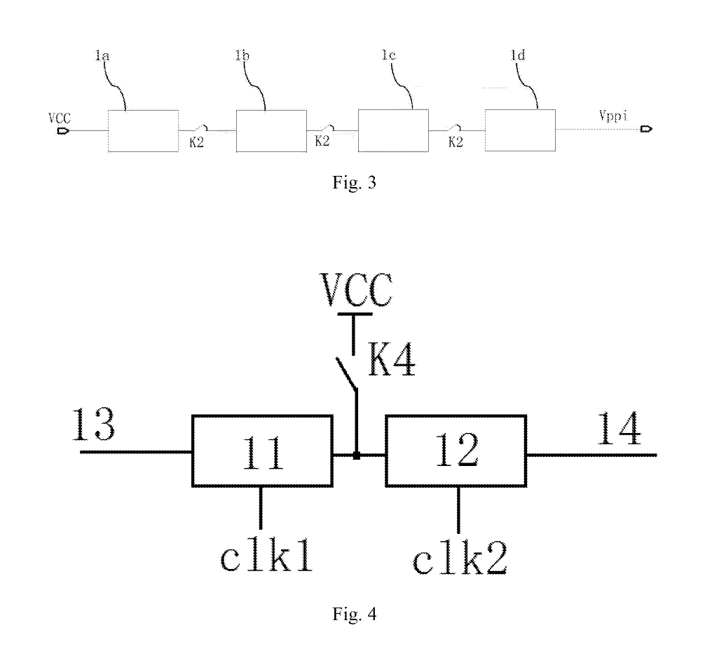

Specifically, if all the switches K2 are opened and all the switches K1, K3 are closed, a parallel-connected charge-pump cascade structure is formed. As shown in FIG. 2, this structure can provide a drive current that is three times a drive current of each single one of the charge-pump stages and an output voltage equal to that of each single charge-pump stage. If all the switches K1, K3 are opened and all the switches K2 are closed, a series-connected charge-pump cascade structure is formed. As shown in FIG. 3, this structure can provide an output voltage that is three times an output voltage of each single one of the charge-pump stages and a drive current equal to that of each single charge-pump stage.

As shown in FIG. 2, the first switches K1 and the third switches K3 may be all closed, the second switches K2 all opened. As a result, the charge-pump stages in the charge-pump cascade structure are connected in parallel. While its output voltage is equal to VCC, it can provide a drive current that is a sum of the drive currents of the individual charge-pump stages in the parallel-connected charge-pump cascade structure. In this configuration, the number of charge-pump stages connected in parallel may be increased or decreased to satisfy specific drive current needs. For example, only two of the first switches K1 (and all of the third switches K3) are closed or only two of the third switches K3 (and all of the first switches K1) are closed to result in a drive current that is twice the drive current of each single charge-pump stage.

Alternatively, as shown in FIG. 3, the first switches K1 and the third switches K3 may be all opened, the second switches K2 all closed. As a result, the charge-pump stages in the charge-pump cascade structure are connected in series instead. In this configuration, the load may require a relatively low drive current which may be dependent on the drive ability of each single charge-pump stage. At the same time, the output voltage of the charge pump is the sum of those of the series-connected charge-pump stages.

As shown in FIG. 4, in the charge pump, each of the charge-pump stages may include two sub-stages 11, 12 connected in series. One sub-stage 11 of the sub-stages has an input 13 serving as an input of the charge-pump stage, and the other sub-stage 12 has an output 14 serving as an output of the charge-pump stage. In each of the charge-pump stages, a node between the two sub-stages may be connected to the supply voltage VCC via a fourth switch K4. Further, the sub-stages may be coupled to respective clock signals. For example, the sub-stage 11 may be coupled to clk1 and the sub-stage 12 to clk2.

In the charge pump proposed in the present invention, through a configuration of the plurality of first, second and third switches K1, K2, K3, and through the opening or closing of the first, second and third switches K1, K2, K3, the connection relationship among the charge-pump stages can be correspondingly changed, thereby forming different charge-pump cascade structures enabling the provision of different output voltages and different drive current abilities that are required to address various drive ability needs for circuit. In this manner, a great drive current can be achieved without increasing the capacitance or the number of stages, offering significant size and cost savings.

In summary, various configurations of the charge pump have been detailed in the above embodiments. Of course, the present invention includes, but not limited to, the configurations disclosed above, and any and all modifications made to these configurations are considered to fall within the scope of the invention. Those skilled in the art can extend the inventive ideas in many ways.

The description presented above is merely that of some preferred embodiments of the present invention and does not limit the scope thereof in any sense. Any and all changes and modifications made by those of ordinary skill in the art based on the above teachings fall within the scope as defined in the appended claims.

What is claimed is:

1. A charge pump, comprising:
a plurality of sequentially connected charge-pump stages;
a plurality of first switches, each coupled between an output of a corresponding one of the charge-pump stages and an output of the charge pump;
a plurality of second switches, each coupled between an output of a corresponding one of the charge-pump stages and an input of an immediately succeeding one of the charge-pump stages; and
a plurality of third switches, each coupled between an output of a corresponding one of the charge-pump stages and an input of the charge pump,
wherein a charge-pump cascade structure is formed by individually configuring an open or close status of each of the first, second and third switches, and wherein a number of series-connected charge-pump stages and a number of parallel-connected charge-pump stages in the charge-pump cascade structure are determined by the open or close status of the respective first, second and third switches, and
wherein a greater number of the series-connected charge-pump stages in the charge-pump cascade structure enables a higher output voltage of the charge pump, and a greater number of the parallel-connected charge-pump stages in the charge-pump cascade structure enables a higher drive current produced by the charge pump.

2. The charge pump of claim 1, wherein among the plurality of sequentially connected charge-pump stages, an input of a leading one of the charge-pump stages serves as an input of the charge-pump cascade structure, and an output of a trailing one of the charge-pump stages serves as an output of the charge-pump cascade structure.

3. The charge pump of claim 1, wherein an input of the charge-pump cascade structure is coupled to a supply voltage and an output of the charge-pump cascade structure is coupled to a load.

4. The charge pump of claim 1, wherein a number of the first switches is one less than a number of the charge-pump stages.

5. The charge pump of claim 1, wherein a number of the second switches is one less than a number of the charge-pump stages.

6. The charge pump of claim 1, wherein a number of the third switches is one less than a number of the charge-pump stages.

7. The charge pump of claim 1, wherein the plurality of charge-pump stages are connectable in parallel by closing each of the first and third switches and opening each of the second switches.

8. The charge pump of claim 1, wherein the plurality of charge-pump stages are connectable in series by opening each of the first and third switches and closing each of the second switches.

9. The charge pump of claim 1, wherein each of the charge-pump stages comprises two sub-stages which are connected in series, one of the two sub-stages having an input serving as an input of the charge-pump stage, the other one of the two sub-stages having an output serving as an output of the charge-pump stage.

10. The charge pump of claim 9, further comprising a plurality of fourth switches, wherein in each of the charge-pump stages, a node between the two sub-stages is connected to a supply voltage via a corresponding one of the fourth switches and each of the sub-stages is coupled to a clock signal.
